(19) United States
(12) Patent Application Publication
(10) Pub. No.: US 2010/0251642 A1
(43) Pub. Date: Oct. 7, 2010

(54) FRAME CASING KIT

(76) Inventor: Ron Erickson, Grantsville, UT (US)

Correspondence Address: ADVANTIA LAW GROUP, 9035 SOUTH 1300 EAST, SUITE 200, SANDY, UT, 84094, US

(21) Appl. No.: 12/418,248

(22) Filed: Apr. 3, 2009

(51) Int. Cl. E06B 1/04; E04C 2/20; E04C 2/30

(52) U.S. Cl. 52/204.1; 52/309.3; 52/312

(57) ABSTRACT

There is a frame casing kit configured to couple to a door frame, including a plurality of casing strips; wherein each of the casing strips are non-ductile. Each of the plurality of casing strips includes ends shaped to couple together to form a complete covering of a rectangular frame. The frame casing includes a clip orthogonally coupled to a side panel, and coupled to a step orthogonally, and also coupled to a face. The clip is configured to couple about a door jamb behind a weather stripping, and the face is configured to cover an exterior portion of a door frame. The frame casing kit further includes an adhesive, such that when the fluid adhesive is applied to an interior surface of a casing strip, to couple to a frame by the adhesive. The frame casing kit further includes an accessory face selectably coupleable to the face.

### BACKGROUND OF THE INVENTION

1. Field of the Invention

The present invention relates to door frames, specifically a frame casing kit.

2. Description of the Related Art

Doors are nearly universal in buildings of all kinds, allowing passage between the inside and outside, and between internal rooms. When open, they admit ventilation and light. The door is used to control the physical atmosphere within a space by enclosing it, excluding air drafts, so that interiors may be more effectively heated or cooled. They are also used to screen areas of a building for aesthetic purposes, keeping formal and utility areas separate. Doors also have an aesthetic role in creating an impression of what lies beyond. However, the exterior of the door frame typically becomes weathered and damaged from the weather and elements in just a couple of years. The exterior door frame continues to need constant maintenance and repair.

This results in continued expense and hassle for home owners and reduces satisfaction in owning a home. The most common type of repair is to repaint the exterior of the door frame. This process is long and burdensome, since most exterior door frames rest upon the exterior finish of the house; wherein painting is typically difficult and tedious. It is hard to easily and conveniently paint the exterior door frame. In some cases, ductile metal flashings such as aluminum panels are attached to frames, but these warp during storage, installation, and use and provide an inadequate support for decorative additions such as paint or facings.

Some improvements have been made in the field. Examples of references related to the present invention are described below, and the supported teachings of each reference are incorporated by reference herein:

U.S. Pat. No. 5,941,033, issued to Adams, discloses a vinyl window finish trim assembly is provided which attaches to an extruded window frame mounted in a window opening. The window finish trim assembly is cut to fit on site or in the factory, and snaps into attachment with the window frame mounted in the window opening. The window finish trim assembly is adjustable for variations in the thicknesses of walls and window frames, and when finished has the appearance of painted wood window trim. It offers a design by which all of the pieces of the window trim are cut from either one, two or three types of extruded stock. Corner pieces are also utilized for ornamentation and structural strength.

U.S. Pat. No. 6,922,958, issued to Derderian, discloses an improved plastic, e.g., vinyl, window construction includes an exterior casing rigidly mounted to a window frame and which may advantageously be pre-attached to the window frame, allowing the window construction to be installed as a single unit. The exterior casing may include an exterior sill and may be constructed to provide the appearance of a traditional wooden window. In another aspect, a window construction with an integrated interior casing is also provided. In yet a further aspect, a method for manufacturing a plastic window construction with integrated exterior casing is provided.

U.S. Pat. No. 5,090,174, issued to Fragale, discloses a siding trim piece has a low gauge layer (preferably metal) of preferably about 0.013 gauge, with a substrate material (preferably foam) laminated to the low gauge layer. An edge of the siding trim piece preferably has an integral J channel. The substrate material is fixed to the structure preferably by an adhesive. A method for siding a structure includes the steps of covering the trim, edges and corners in a structure with the siding trim pieces having an integral J channel, and covering the exterior surfaces with siding by inserting ends of the siding into the J channels of the siding trim pieces to abut the siding with the trim, edges and corners of the structure without interposing a separate intermediate seam covering material between the siding, corners, edges and trim. The invention provides a wood-like appearance and avoids the appearance of discontinuities between the siding and trim, edges and corners of the structure.

U.S. Pat. No. 6,526,707, issued to Tucker, discloses a trim strip for use around window and door opening and a method of installing the same. The trim strip includes a unitary body having an elongate first planar portion and an elongate second planar portion in parallel spaced relation. A second edge of the second planar portion is connected to a second edge of the first planar portion. A third planar portion is secured substantially perpendicularly to a first edge of the first planar portion and extends transversely in spaced relation past a first end of the second planar portion. The trim strip is intended for installation onto any building after a “J” strip trim or equivalent has been secured around the window and door openings. It is particularly suited for retrofitting a building that has exterior siding.

U.S. Pat. No. 5,103,612, issued to Wright, discloses a flexible trim member or molding for use when installing siding or coping on building structures. The trim member is fabricated of accordian or pleated type construction to allow for placement upon inside corners and edges that are uneven or irregular. The trim member easily accommodates itself to the irregularities to facilitate the placement of the siding or coping that butts against the uneven corners or edges.

U.S. Pat. No. 5,022,204, issued to Anderson, discloses a window and door trim which can be used with siding placed against the walls of a house. The trim includes elongated composite panels each comprising a receiving strip member and a facing strip member. The receiving member is formed with a folded hem having a receiving slot and has a flat portion securable to the front face of the window or door casing. The facing member is L-shaped. Its shorter leg is inserted in the receiving slot of the receiving member while its longer leg is adapted to enclose an end portion of the siding and be secured to the wall of the house. Corner trim arrangements and corner caps are also provided.

U.S. Pat. No. 4,843,790, issued to Taravella, discloses a casing trim, and the combination therewith of a flat vinyl strip, and the method of concealing building wooden casings and the like, wherein the casing trim is nailed to the edge portion of a casing, with one flange of the casing trim extending over an edge of the casing, and the perpendicularly directed face portion has a channel which receives and retains an edge of the flat vinyl strip. In an added embodiment, the flat vinyl strip is replaced by a wide cap having a rearwardly extending flange, for engagement in a forwardly extending channel of a receiver, all of which are disposed around the edge of adjacent vinyl siding.

The inventions heretofore known suffer from a number of disadvantages which include being difficult to install, being cumbersome to install, being limited in application, being limited in adaptability, being too expensive, being unduly complex to install, and needing the assistance of a professional craftsman.

What is needed is a framing casing kit that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available frame casing kits. Accordingly, the present invention has been developed to provide a long lasting door frame casing kit.

In one embodiment of the invention, there is a frame casing kit configured to couple to a door frame, comprising: a plurality of casing strips configured to couple to a door frame thereby covering the door frame of a house. Each of the casing strips are non-ductile and may include a preformed cross-section shaped to abut and cover the frame, wherein each of the plurality of casing strips have ends shaped to couple together to form a complete covering of a rectangular frame. Each of the casing strips may consist essentially of, in material, vinyl, wherein the preformed cross-section may include a clip orthogonally coupled to a side panel coupled to a step orthogonally coupled to a face. The face may include a coupling interface configured to securely couple without adhesive to another object. The clip may be configured to couple about a door jamb behind a weather stripping, and the face may be configured to cover an exterior portion of a door frame.

The frame casing kit may further include an adhesive having a characteristic of adhering to the plurality of casing strips, such that when the fluid adhesive is applied to an interior surface of a casing strip, the casing strip may be thereby coupled to a frame by the adhesive. An accessory face may be selectably coupleable to the face, wherein the accessory face is selectably coupled to the face by collaborative tongue and groove structures on the accessory face and face. The accessory face may be coupled across a front of the face and may include a decorative surface. The accessory face may couple orthogonally to the face and thereby forms a clip. The accessory face may extend approximately in line with the face when coupled thereto. Furthermore, each of the casing strips may consist essentially of, in material, fiberglass.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a cross-sectional view of a frame casing, according to one embodiment of the invention;

FIG. 2 is a cross-sectional view of a frame casing including attachments, according to one embodiment of the invention;

FIG. 3 is a cross-sectional view of a frame casing, according to one embodiment of the invention;

FIG. 4 is a cross-sectional view of a frame casing, according to one embodiment of the invention;

FIG. 5 is a cross-sectional view of a frame casing, according to one embodiment of the invention;

FIG. 6 is a cross-sectional view of a frame casing, according to one embodiment of the invention; and

FIG. 7 is a perspective view of a frame casing, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example”, or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like, described herein are considered to be able to be combined in whole, or in part one with another, as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

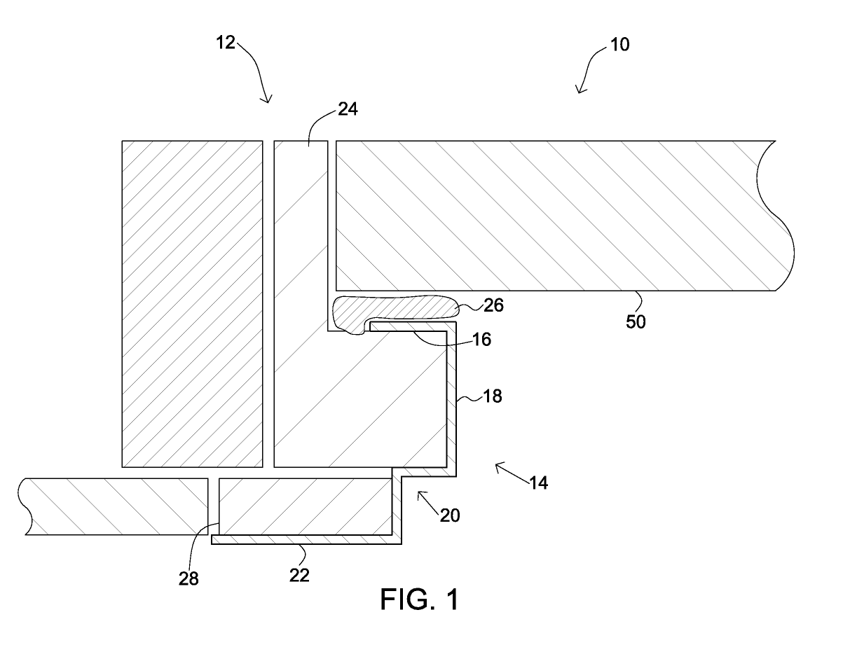

FIG. 1 is a cross-sectional view of a frame casing 10, according to one embodiment of the invention; wherein the frame casing 10 is configured to couple to a door frame. The frame casing 10 includes a plurality of casing strips 14 configured to couple to a door frame 12 thereby covering the door frame 12 of a house. Each of the casing strips 14 are non-ductile and include a pre-formed cross-section shaped to abut and cover the frame and wherein each of the plurality of casing strips have ends shaped to couple together to form a complete covering of a rectangular frame. Each of the casing strips consist essentially of, in material, vinyl, or fiberglass. Advantageously, a non-ductile strip provides enhanced performance and durability, allows for easier cutting to desired lengths without deforming, and is less likely to deform critical structures to a state on inoperability, such as, but not limited to tongue and groove portions.

In addition, the pre-formed cross-section includes a clip 16 orthogonally coupled to a side panel 18 coupled to a step 20 orthogonally coupled to a face 22. The clip 16 is configured to couple about a door jamb 24 behind a weather stripping 26, and the face 22 is configured to cover an exterior portion of a door frame 28. As illustrated in FIG. 1, a door 50 is in a closed position disposed adjacent to the weather stripping 26 and the door jamb 24.

In operation of one embodiment of the invention, a user measures the existing door frame and cuts each of the casing strips to fit and cover the door frame. The user disposes an adhesive along the internal edges of each of the casing strips. Then, the user inserts the clip in between the door jamb and the weather stripping of the door and fits the casing strips over the exterior of the door frame. The user couples each of the plurality of casing strips together by coupling the ends together to form a complete covering of a rectangular frame. The casing strips abut up against each other forming the rectangular frame around the door.

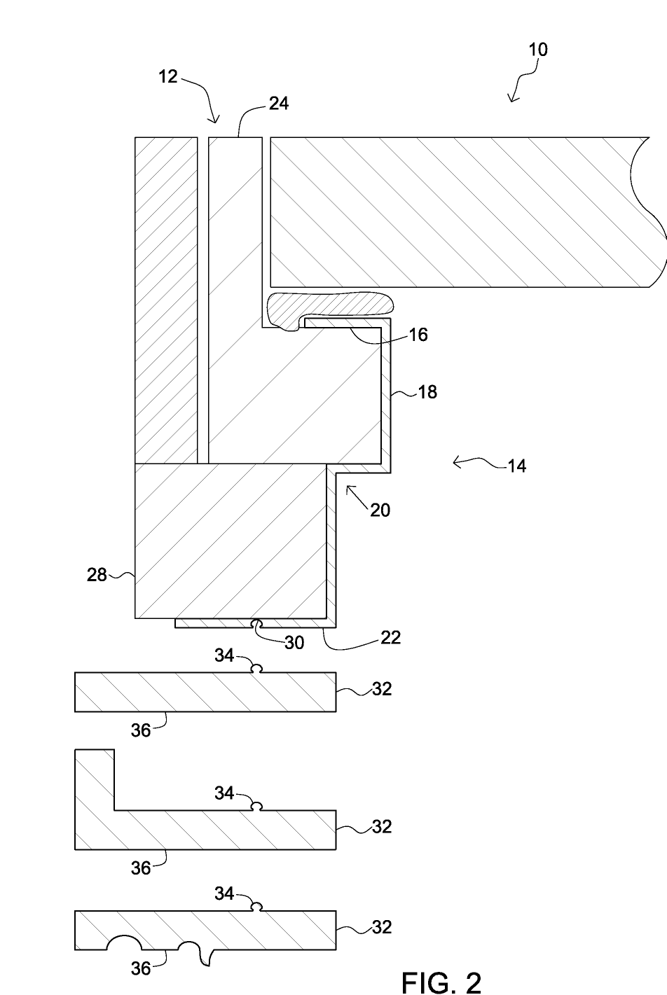

FIG. 2 is a cross-sectional view of a frame casing 10 including attachments, according to one embodiment of the invention; wherein the frame casing 10 and attachments are configured to couple to a door frame. The frame casing 10 includes a plurality of casing strips 14 configured to couple to a door frame 12 thereby covering the door frame 12 of a house. Each of the casing strips 14 include a pre-formed cross-section shaped to abut and cover the frame, wherein each of the plurality of casing strips have ends shaped to couple together to form a complete covering of a rectangular frame. The pre-formed cross-section includes a clip 16 orthogonally coupled to a side panel 18 coupled to a step 20 orthogonally coupled to a face 22. The face 22 includes a coupling interface 30 configured to securely couple, without adhesive, to another object. The clip 16 is configured to couple about a door jamb 24 behind a weather stripping 26, and the face 22 is configured to cover an exterior portion 28 of a door frame 12. The frame casing 10 further includes an accessory face 32; wherein the accessory face 32 is selectably coupleable to the face 22; wherein the accessory face 32 is selectably coupled to the face 22 by collaborative tongue and groove structures on the accessory face and face 30, 34. The accessory face 32 is coupled across a front of the face 22 and also includes a decorative surface 36. The accessory face 32 extends approximately in line with the face 22 when coupled thereto.

In operation of one embodiment of the invention, a user measures the existing door frame and cuts each of the casing strips to fit the door frame. The user disposes an adhesive along the internal edges of each of the casing strips. The user inserts the clip in between the door jamb and the weather stripping of the door. The casing strip fits about the exterior of the door frame. The user couples each of the plurality of casing strips together by coupling the ends together to form a complete covering of a rectangular frame. The user then couples an accessory face to the face of the casing strip, wherein the accessory face is selectably coupled to the face by collaborative tongue and groove structures on the accessory face and face. The accessory face is coupled across a front of the face, wherein the accessory face also includes a decorative surface, such as a trim around the door frame.

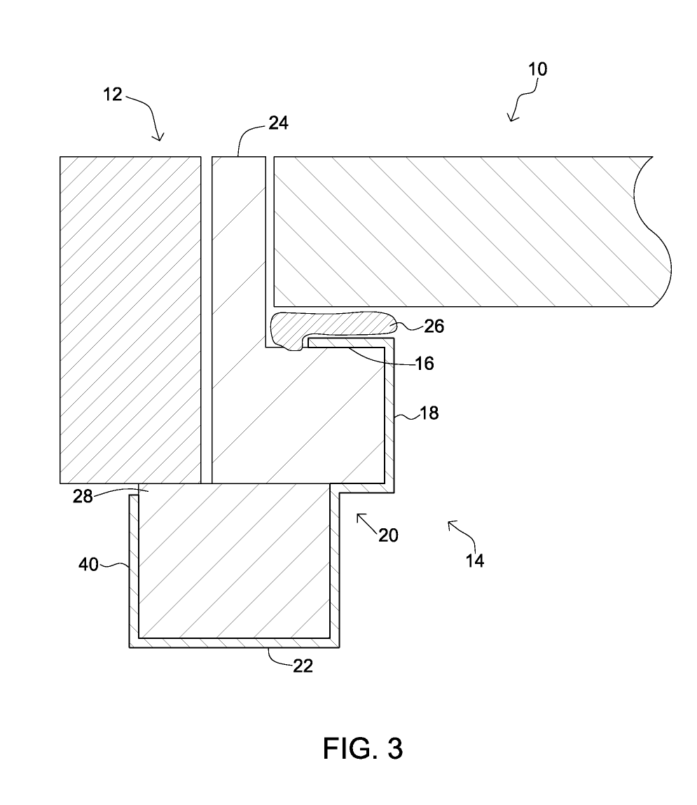

FIG. 3 is a cross-sectional view of a frame casing 10, according to one embodiment of the invention, wherein the frame casing 10 is configured to couple to a door frame. The frame casing 10 includes a plurality of casing strips 14 configured to couple to a door frame 12 thereby covering the door frame 12 of a house. Each of the casing strips 14 are non-ductile and include a pre-formed cross-section shaped to abut and cover the frame 12. Each of the plurality of casing strips 14 includes ends shaped to couple together to form a complete covering of a rectangular frame. In addition, the pre-formed cross-section includes a clip 16 orthogonally coupled to a side panel 18 coupled to a step 20 orthogonally coupled to a face 22. The clip 16 is configured to couple about a door jamb 24 behind a weather stripping 26, and the face 22 is configured to cover an exterior portion of a door frame 28. Furthermore, the casing strip 14 also an accessory face coupled orthogonally to the face 22 and thereby forms a clip 40; wherein the clip 40 covers the brick mold of the exterior portion of the door frame 28.

In operation of one embodiment of the invention, a user measures the existing door frame and cuts each of the casing strips to fit the door frame. The user disposes an adhesive along the internal edges of each of the casing strips. The user inserts the clip in between the door jamb and the weather stripping of the door. The casing strip fits about the exterior of the door frame. The user couples each of the plurality of casing strips together by coupling the ends together to form a complete covering of a rectangular frame.

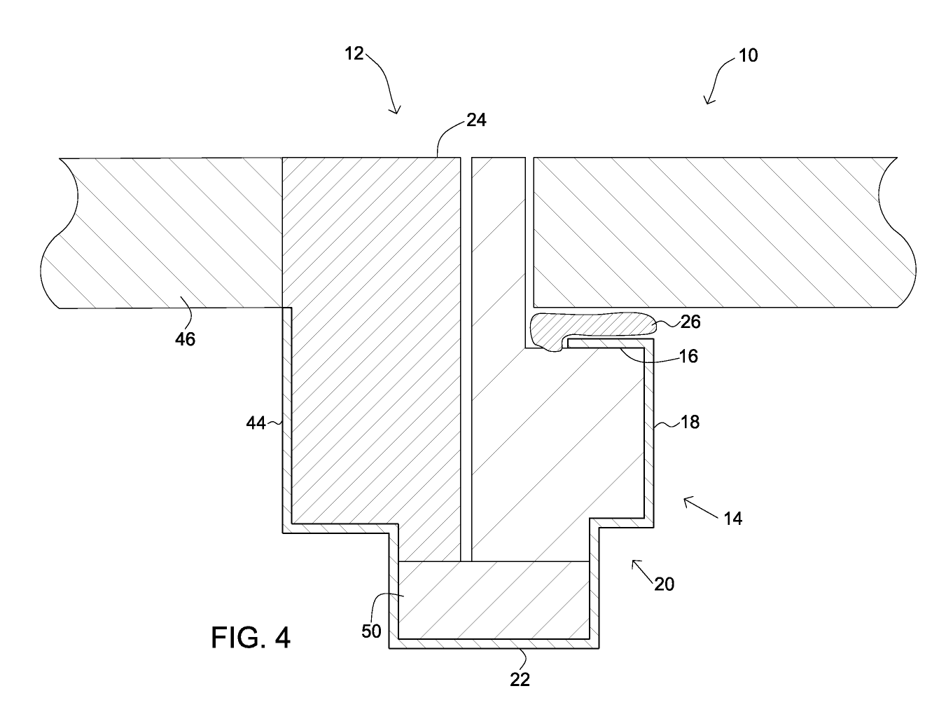

FIG. 4 is a cross-sectional view of a frame casing 10, according to one embodiment of the invention, wherein the frame casing 10 is configured to couple to a door frame. The frame casing 10 includes a plurality of casing strips 14 configured to couple to a door frame 12 thereby covering the door frame 12 of a house. Each of the casing strips 14 are non-ductile and include a pre-formed cross-section shaped to abut and cover the frame. Each of the plurality of casing strips includes ends shaped to couple together to form a complete covering of a rectangular frame. In addition, the pre-formed cross-section includes a clip 16 orthogonally coupled to a side panel 18, coupled to a step 20, orthogonally coupled to a face 22. The clip 16 is configured to couple about a door jamb 24 behind a weather stripping 26, and the face 22 is configured to cover an exterior portion of a door frame, or a wood lattice 50. Furthermore, the casing strip 14 also includes an accessory face coupled orthogonally to the face 22 and thereby forms an extension member 44, wherein the extension member 44 covers the exterior portion of the door frame, wood lattice 50, and is configured to extend back to a side window 46.

In operation of one embodiment of the invention, a user measures the existing door frame and cuts each of the casing strips to fit the door frame. The user disposes an adhesive along the internal edges of each of the casing strips. The user inserts the clip in between the door jamb and the weather stripping of the door. The casing strip fits about the exterior of the door frame. The user couples each of the plurality of casing strips together by coupling the ends together to form a complete covering of a rectangular frame.

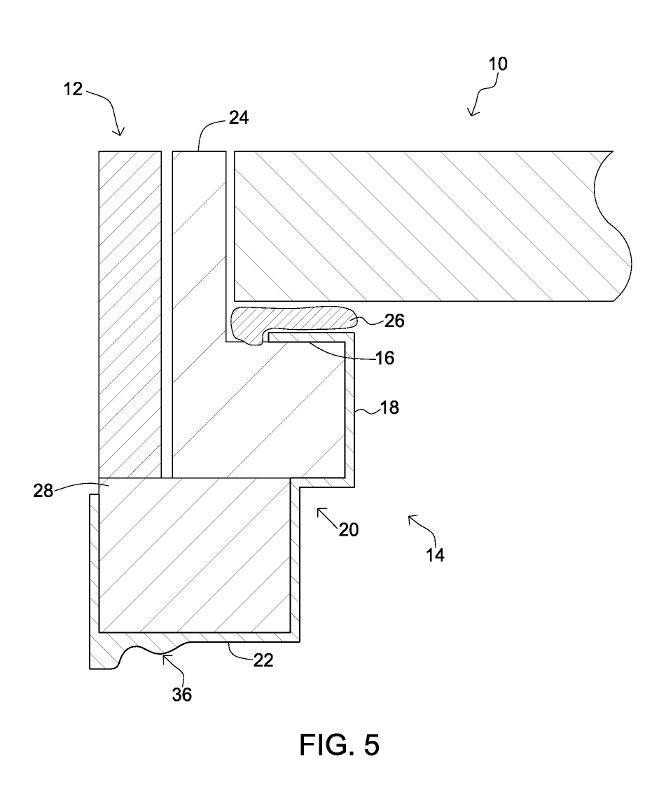

FIG. 5 is a cross-sectional view of a frame casing 10, according to one embodiment of the invention, wherein the frame casing 10 is configured to couple to a door frame. The frame casing 10 includes a plurality of casing strips 14 configured to couple to a door frame 12 thereby covering the door frame 12 of a house. Each of the casing strips 14 are non-ductile and include a pre-formed cross-section shaped to abut and cover the frame; wherein each of the plurality of casing strips have ends shaped to couple together to form a complete covering of a rectangular frame. In addition, the pre-formed cross-section includes a clip 16 orthogonally coupled to a side panel 18 coupled to a step 20 orthogonally coupled to a face 22. The clip 16 is configured to couple about a door jamb 24 behind a weather stripping 26, and the face 22 is configured to cover an exterior portion of a door frame 28. The casing strip 14 also includes an accessory face coupled across a front of the face 22 and also includes a decorative surface 36. The accessory face extends approximately in line with the face 22 when coupled thereto.

In operation of one embodiment of the invention, a user measures the existing door frame and cuts each of the casing strips to fit the door frame. The user disposes an adhesive along the internal edges of each of the casing strips. The user inserts the clip in between the door jamb and the weather stripping of the door. The casing strip fits about the exterior of the door frame. The user couples each of the plurality of casing strips together by coupling the ends together to form a complete covering of a rectangular frame.

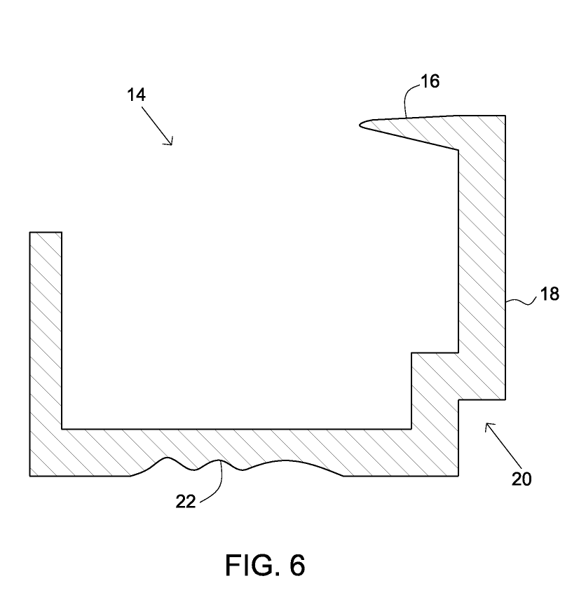

FIG. 6 is a cross-sectional view of a frame casing 10, according to one embodiment of the invention; wherein the frame casing 10 includes a plurality of casing strips 14 configured to couple to a door frame 12 thereby covering the door frame 12 of a house. Each of the casing strips 14 are non-ductile and include a pre-formed cross-section shaped to abut and cover the frame, wherein each of the plurality of casing strips have ends shaped to couple together to form a complete covering of a rectangular frame. The pre-formed cross-section includes a clip 16 orthogonally coupled to a side panel 18 coupled to a step 20 orthogonally coupled to a face 22. The clip 16 is configured to couple about a doorjamb 24 behind a weather stripping 26, and the face 22 is configured to cover an exterior portion of a door frame 28.

In operation of one embodiment of the invention, a user measures the existing door frame and cuts each of the casing strips to fit the door frame. The user disposes an adhesive along the internal edges of each of the casing strips. The user inserts the clip in between the door jamb and the weather stripping of the door. The casing strip fits about the exterior of the door frame. The user couples each of the plurality of casing strips together by coupling the ends together to form a complete covering of a rectangular frame.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a single casing strip of a plurality of casing strips, one skilled in the art of the invention would appreciate that the plurality of casing strips may be included in a kit; wherein the kit includes casing strips having cutting marks disposed on the interior of each casing strip. The cutting marks may be marked at the standard sizes of door frames, such as, but not limited to: 2′8″, 3′0″, 3′2″ and still perform its intended function. The kit is configured to enable one with ordinary skill in the art to easily install the casing strips around a door frame like a professional craftsman.

Additionally, although the figures illustrate cross-sectional views of the casing strips, one skilled in the art would appreciate that the casing strips may include a plurality of finishes. Non-limiting examples may be, but not limited to, wood finish, colored finish, wood grain finish, natural finish, etc. and still perform its intended function.

It is envisioned that the casing strips may couple together by abutting up against each other, thereby forming a rectangular frame. One skilled in the art would appreciate that the casing strips may couple together by a variety of configurations; examples are, but not limited to, snap coupling configuration, tongue and groove configuration, and any other coupling device known in the art and still perform its intended function.

It is also envisioned that one skilled in the art would appreciate that each of the casing strips may be pre-cut to 45 degree angles to enable a user to form a complete covering of a rectangular frame without the need to measure the casing strips and the need for complex tools and machinery, and still perform its intended function.

It is expected that there could be numerous variations of the design of this invention. An example is that the casing strips may be configured to cover French doors, double doors, sliding doors, etc. and still perform its intended function.

While particular add-ons have been illustrated, it is understood that the variety of add-on pieces, or accessories, that may be attached by tongue and groove are many and varied. Further, while add-ons of particular shapes are disclosed, it is understood that such may be varied aesthetically while retaining substantially the same function, structure, and/or purpose.

Finally, while tongue and groove coupling systems are disclosed and described, it is understood that other structures for coupling accessories to casings may be utilized and that combinations may also be utilized. Non-limiting examples include: snaps, clips, hooks, hook and loop, friction-fit, ball and socket, hinges, screws, and the like.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made without departing from the principles and concepts of the invention as set forth in the claims. Further, it is contemplated that an embodiment may be limited to consist of, or to consist essentially of, one or more of the features, functions, structures, methods described herein.

What is claimed is:

1. A frame casing kit configured to couple to a door frame, consisting of:
a) a plurality of casing strips configured to couple to a door frame thereby covering the door frame of a house,
wherein each of the casing strips is non-ductile and has a pre-formed cross-section shaped to abut and cover the frame and wherein each of the plurality of casing strips have ends shaped to couple together to form a complete covering of a rectangular frame, and
wherein the pre-formed cross-section includes a clip orthogonally coupled to a side panel coupled to a step orthogonally coupled to a face and wherein the clip is configured to couple about a door jamb behind a weather stripping and the face is configured to cover an exterior portion of a door frame; and
b) an adhesive having a characteristic of adhering to the plurality of casing strips, such that when the fluid adhesive is applied to an interior surface of a casing strip, the casing strip may be thereby coupled to a frame by the adhesive.

2. The frame casing kit of claim 1, wherein the face comprises a coupling interface configured to securely couple without adhesive to another object.

3. The frame casing kit of claim 1, wherein each of the casing strips consists essentially of, in material, vinyl.

4. The frame casing kit of claim 1, further comprising an accessory face selectably coupleable to the face.

5. The frame casing kit of claim 4, wherein the accessory face is selectably coupled to the face by collaborative tongue and groove structures on the accessory face and face.

6. The frame casing kit of claim 4, wherein the accessory face is coupled across a front of the face and includes a decorative surface.

7. The frame casing kit of claim 4, wherein the accessory face couples orthogonally to the face and thereby forms a clip.

8. The frame casing kit of claim 4, wherein the accessory face extends approximately in line with the face when coupled thereto.

9. The frame casing kit of claim 1, wherein each of the casing strips consists essentially of, in material, fiberglass.

10. A framed access portion of a house configured to provide access to the house for the purposes of entrance, light, or air, comprising:
a) a plurality of casing strips configured to couple to a framed access portion of a house, thereby covering the framed access portion of the house,
wherein each of the casing strips is non-ductile and has a pre-formed cross-section shaped to abut and cover the framed access portion, and wherein each of the plurality of casing strips have ends shaped to couple together to form a complete covering of the framed access portion, and
wherein the pre-formed cross-section includes a clip orthogonally coupled to a side panel coupled to a step orthogonally coupled to a face;
wherein the clip is coupled about a door jamb behind a weather stripping and the face covers an exterior portion of the door frame; and
an adhesive having a characteristic of adhering to the plurality of casing strips, such that when the fluid adhesive is applied to an interior surface of a casing strip, the casing strip may be thereby coupled to the framed access portion of the house by the adhesive.

11. The framed access portion of claim 10, wherein the face comprises a coupling interface configured to securely couple without adhesive to another object.

12. The framed access portion of claim 11, wherein each of the casing strips consists essentially of, in material, vinyl.

13. The framed access portion of claim 12, further comprising an accessory face selectably coupleable to the face.

14. The framed access portion of claim 13, wherein the accessory face is selectably coupled to the face by collaborative tongue and groove structures on the accessory face and face.

15. The framed access portion of claim 13, wherein the accessory face is coupled across a front of the face and includes a decorative surface.

16. The framed access portion of claim 13, wherein the accessory face couples orthogonally to the face and thereby forms a clip.

17. The framed access portion of claim 13, wherein the accessory face extends approximately in line with the face when coupled thereto.

18. The framed access portion of claim 10, wherein each of the casing strips consists essentially of, in material, fiberglass.

19. A frame casing kit configured to couple to a door frame, comprising:
a) a plurality of casing strips configured to couple to a door frame thereby covering the door frame of a house,
wherein each of the casing strips is non-ductile and has a pre-formed cross-section shaped to abut and cover the frame and wherein each of the plurality of casing strips have ends shaped to couple together to form a complete covering of a rectangular frame, wherein each of the casing strips consists essentially of, in material, vinyl; and
wherein the pre-formed cross-section includes a clip orthogonally coupled to a side panel coupled to a step orthogonally coupled to a face; wherein the face comprises a coupling interface configured to securely couple without adhesive to another object, wherein the clip is configured to couple about a doorjamb behind a weather stripping and the face is configured to cover an exterior portion of a door frame;
b) an adhesive having a characteristic of adhering to the plurality of casing strips, such that when the fluid adhesive is applied to an interior surface of a casing strip, the casing strip may be thereby coupled to a frame by the adhesive; and
c) an accessory face selectably coupleable to the face; wherein the accessory face is selectably coupled to the face by collaborative tongue and groove structures on the accessory face and face; and wherein the accessory face is coupled across a front of the face and includes a decorative surface; and wherein the accessory face couples orthogonally to the face and thereby forms a clip; and wherein the accessory face extends approximately in line with the face when coupled thereto.

20. The frame casing kit of claim 19, wherein each of the casing strips consists essentially of, in material, fiberglass.
